(19) United States
(12) Patent Application Publication
(10) Pub. No.: US 2009/0013123 A1
(43) Pub. Date: Jan. 8, 2009

(54) Storage Bridge and Storage Device and Method Applying the Storage Bridge

(76) Inventor: Chun-Yu Hsieh, Tai-Chung City (TW)

Correspondence Address: NORTH AMERICA INTELLECTUAL PROPERTY CORPORATION, P.O. BOX 506, MERRIFIELD, VA, 22116, US

(21) Appl. No.: 11/772,819

(22) Filed: Jul. 2, 2007

(51) Int. Cl. G06F 12/00

(52) U.S. Cl. 711/103; 711/112; 711/E12.008; 711/E12.002

(57) ABSTRACT

A storage bridge includes a flash memory register unit for temporarily storing data and for storing data of a storage unit when a host unit stores data to the storage unit, and a transmission interface control unit coupled to the flash memory register unit for controlling operations of the flash memory register unit.

### BACKGROUND OF THE INVENTION

1. Field of the Invention

The present invention relates to a storage bridge and a storage device and method applying the storage bridge, and more particularly, to a storage bridge for temporarily storing transmitted data and for storing storage information of a storage unit to enhance data transmission reliability by a flash memory register unit.

2. Description of the Prior Art

With advanced development of computer technology, the size of a computer system is gradually being reduced. The computer system is now used in a broad spectrum of fields. In order to expand additional functions of the computer system to meet requirements of different users, many kinds of external devices are invented under this situation. For example, an external hard disk drive or other portable data storage devices can increase the total data storage capacity of the computer system. An external optical drive and an external optical recordable drive can provide the computer system with an additional ability of accessing multimedia data recorded on compact discs and storing a great quantity of back-up data on the compact disc. In addition, an IC smart card and an external network card can individually provide other functions to make the computer system become a more powerful tool for users. However, in order to enable the external storage device capable to work normally, a basic requirement is establishing an effective data transmission interface for the host system capable of transmitting data with various storage devices efficiently. Therefore, a variety of industry standard transmission protocols have been developed and are currently in use, such as versions of a Universal Serial Bus (USB), IEEE 1394 interface, and external serial ATA (eSATA) interfaces as a few examples. In this situation, an intermediate device, or bridge, is often used between the storage device and the host system to permit effective data transmission.

Please refer to FIG. 1. FIG. 1 is a functional block diagram of a prior art system 10. The system 10 includes a host unit 11 and a storage device 15. The host unit 11 is a computer host or any apparatus capable of generating data that needs to be stored, such as a digital camera. The storage device 15, coupled to the host unit 11, is utilized for receiving and storing data from the host unit 11, and includes a storage bridge 151 and a storage unit 152. The storage bridge 151 is coupled between the host unit 11 and the storage unit 152, and is utilized for providing a data transmission interface, so that the host unit 11 and the storage bridge 151 can perform data transmission according to a first transmission protocol, and the storage bridge 151 and the storage unit 152 can perform data transmission according to a second transmission protocol. Therefore, through the storage bridge 151, the data from the host unit 11 can be transformed to a format compatible with the storage unit 152. Furthermore, the storage bridge 151 often includes a transmission interface control unit 153 for controlling operations of the storage bridge 151 and corresponding data transmission according to commands of the host unit 11.

However, in such structures, when an accidental interruption occurs during data transmission, for example, an external hard disk connecting with the computer host is abnormally removed or shut down when data is being transmitted, the transmitted data may suffer damages or loss since the data is still in the operation of data format transformation or in the process of data transmission. Therefore, it is a main concern for those skilled in the art to prevent the transmitted data from being lost and being damaged due to accidental interruption of data transmission.

### SUMMARY OF THE INVENTION

It is therefore a primary objective of the present invention to provide a storage bridge and a storage device and method applying the storage bridge.

The present invention discloses a storage bridge. The storage bridge includes a flash memory register unit for temporarily storing data and for storing storage information of a storage unit when a host unit stores the data to the storage unit; and a transmission interface control unit coupled to the flash memory register unit for controlling the flash memory register unit.

The present invention further discloses a storage device. The storage device includes a reception end, coupled to a host unit, for receiving data of the host unit; a storage unit for storing the data of the host unit; and a storage bridge, coupled between the reception end and the storage unit, for providing a data transmission interface between the host unit and the storage unit. The storage bridge includes a flash memory register unit for temporarily storing the data and storing storage information of the storage unit when the host unit stores the data to the storage unit; and a transmission interface control unit coupled to the flash memory register unit for controlling the flash memory register unit.

The present invention further discloses a data storage method. The data storage method includes temporarily storing data by a flash memory register unit of a storage bridge when a host unit stores the data to a storage unit through the storage bridge; storing the data to the storage unit; and storing storage information of the storage unit into the flash memory register unit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a prior art system.

FIG. 2 is a schematic diagram of a storage device according to an embodiment of the present invention.

FIG. 3 is a flow chart diagram of a process for enhancing data transmission reliability through the storage bridge in FIG. 2.

FIG. 4 and FIG. 5 are schematic diagrams of data transmission paths corresponding to the process in FIG. 3.

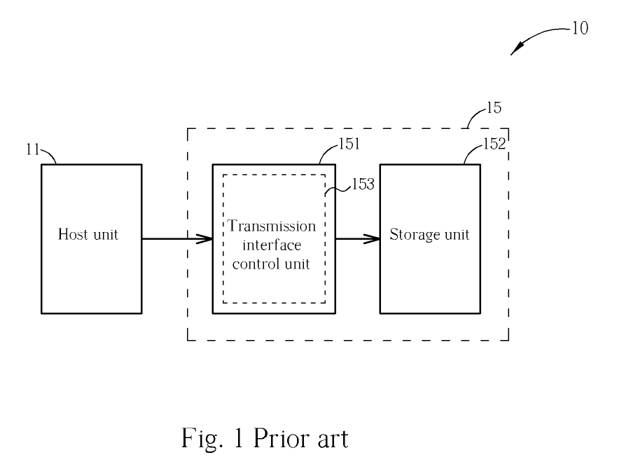

### DETAILED DESCRIPTION

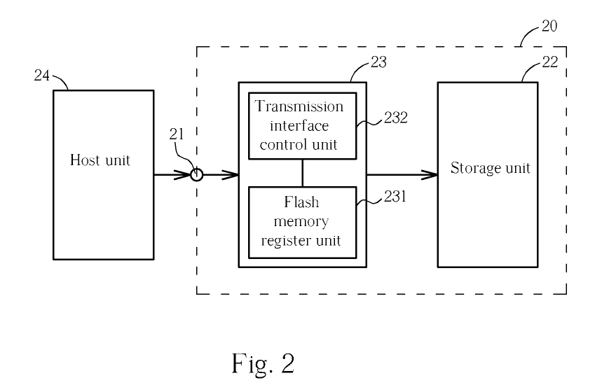

Please refer to FIG. 2. FIG. 2 is a schematic diagram of a storage device 20 according to an embodiment of the present invention. The storage device 20 includes a reception end 21, a storage unit 22, and a storage bridge 23. The reception end 21 is coupled to a host unit 24, and is utilized for receiving data of the host unit 24. Preferably, the host unit 24 can be a computer host or any other apparatus capable of generating data, such as a digital camera, a digital video camera and so on. The storage unit 22 is utilized for storing the data that the host unit 24 is about to store. The storage bridge 23, coupled between the reception end 21 and the storage unit 22, is utilized for providing a data transmission interface between the host unit 24 and the storage unit 22, and includes a flash memory register unit 231 and a transmission interface control unit 232. The flash memory register unit 231 is utilized for temporarily storing the data and for storing storage information of the storage unit 22 when the host unit 24 stores the data to the storage unit 22. The transmission interface control unit 232, coupled to the flash memory register unit 231, is utilized for controlling operations of the flash memory register unit 231 and for performing data transmission accordingly.

Therefore, during data transmission, the storage bridge 23 of the present invention can temporarily store the transmitted data through the flash memory register unit 231 for preventing the data from being lost or being damaged due to accidental interruption of data transmission such as if the storage device is abnormally removed or shut down. Besides, with the flash memory register unit 231, the storage bridge 23 of the present invention can further store the storage information of the storage unit 22, such as a file allocation table (FAT) or sector information of the storage unit 22, for reconstructing and repairing damaged storage information after data transmission is accidentally interrupted. In other words, since the file allocation table or the sector information of the storage unit 22 may be damaged, with the file allocation table or the sector information backed up in the flash memory register unit 231, the present invention can thus reconstruct and repair the damaged file allocation table or sector information of the storage unit 22, so that the possibility that errors occur can be reduced effectively and the reliability of the storage device can further be enhanced.

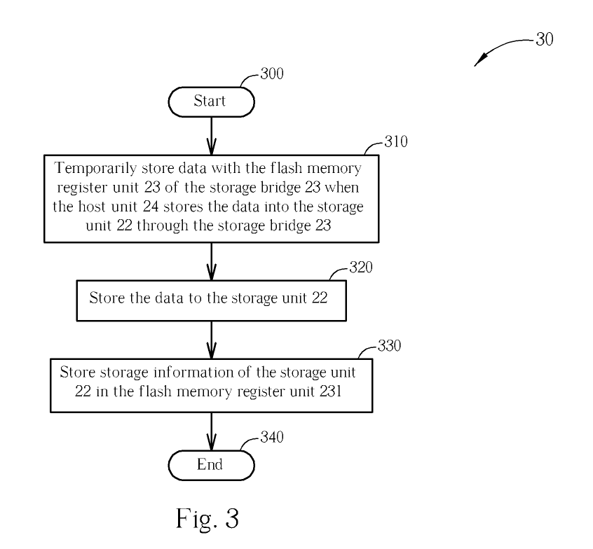

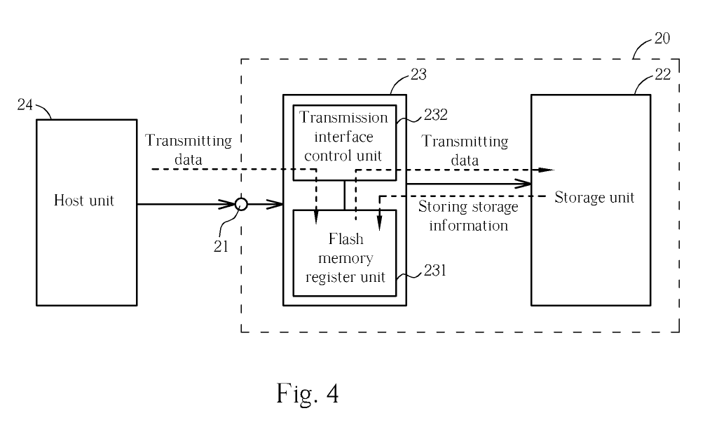

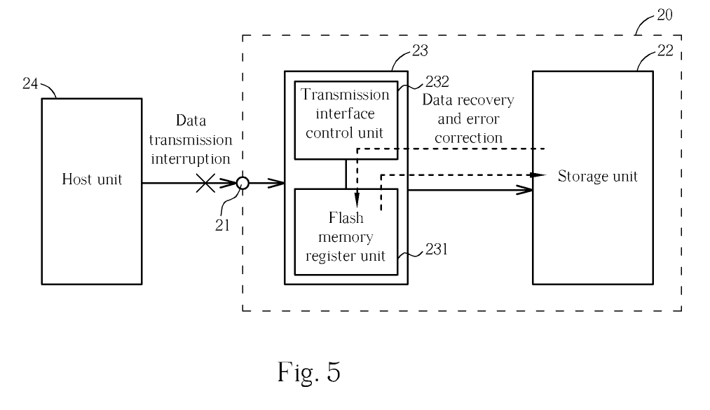

Please refer to FIG. 3-FIG. 5. FIG. 3 is a flow chart diagram of a process 30 for enhancing data transmission reliability through the storage bridge 23 in FIG. 2; and FIG. 4 and FIG. 5 are schematic diagrams of data transmission paths corresponding to the process in FIG. 3. The process 30 is applied for the storage device 20 of the present invention. When the host unit 24 is about to store data into the storage unit 22 (Step 300), the present invention first temporarily stores the data into the flash memory register unit 231 under control of the transmission interface control unit 232 (Step 310). Then, the present invention stores the data in available space of the storage unit 22 through the transmission interface control unit 232 (Step 320). At the same time, the transmission interface control unit 232 also stores the storage information of the storage unit 22 into the flash memory register unit 231 (Step 330), and finally ends the process 30 (Step 340).

If an accidental interruption occurs during data transmission, such as a black-out or the storage device is abnormally removed, the transmitted data and the sector information of the storage unit 22 may be lost or be damaged. At this time, the transmission interface control unit 232 can repair or recover the storage unit 22 and/or its interior stored data according to the damaged condition of the storage unit 22 and the temporarily stored data in the flash memory register unit 231. In addition, please note that the transmission interface control unit 232 of the present invention can be realized by any physical circuits with the same function or by firmware, which are still in the range of the present invention. Therefore, by comparison, the storage bridge of the present invention not only provides a data transmission interface that allows the host unit and the storage bridge to perform data transmission according to a first transmission protocol and allows the storage bridge and the storage unit to perform data transmission according to a second transmission protocol, but also can be utilized for enhancing the data transmission reliability, so that the data transmission efficiency of the storage device can be enhanced and working life of the storage device can further be extended as well.

As mentioned above, by the flash memory register unit, the storage bridge capable of enhancing data transmission reliability in the present invention can temporarily store the transmitted data and store the storage information of the storage unit for preventing the data from being lost or being damaged due to accidental interruption of data transmission. In addition, the storage device of the present invention can be an external storage device, and the storage unit in the storage device can be a mechanical storage unit, such as a hard disk or an optical disc drive. Therefore, by utilizing the flash memory register unit as a temporary storage medium during data transmission, the present invention can significantly reduce the number of read/write times that the read/write head of the mechanical storage unit operates for extending working life of the storage device, so that the efficiency of the storage device can further be enhanced.

Those skilled in the art will readily observe that numerous modifications and alterations of the device and method may be made while retaining the teachings of the invention.

What is claimed is:

1. A storage bridge comprising:
a flash memory register unit for temporarily storing data and for storing storage information of a storage unit when a host unit stores the data to the storage unit; and
a transmission interface control unit coupled to the flash memory register unit for controlling the flash memory register unit.

2. The storage bridge of claim 1, wherein the transmission interface control unit is utilized for controlling the flash memory register unit to temporarily store the data and for storing the data in the storage unit after a predetermined time or after receiving a specific signal when the host unit stores the data to the storage unit.

3. The storage bridge of claim 1, wherein the transmission interface control unit is utilized for controlling the flash memory register unit to store the storage information of the storage unit.

4. The storage bridge of claim 1, wherein the transmission interface control unit is utilized for restoring and recovering the storage unit and/or its interior data by the storage information of the storage unit and the temporarily stored data, stored by the flash memory register unit, when error of transmission between the host unit and the storage unit occurs.

5. The storage bridge of claim 1, wherein the storage information is a file allocation table (FAT).

6. The storage bridge of claim 1, wherein the storage information is sector information.

7. The storage bridge of claim 1, wherein the storage unit is a mechanical storage unit.

8. The storage bridge of claim 7, wherein the storage unit is a hard disk.

9. The storage bridge of claim 7, wherein the storage unit is an optical disk drive.

10. A storage device comprising:
a reception end, coupled to a host unit, for receiving data of the host unit;
a storage unit for storing the data of the host unit; and
a storage bridge, coupled between the reception end and the storage unit, for providing a transmission interface between the host unit and the storage unit, the storage bridge comprising:
a flash memory register unit for temporarily storing the data and storing storage information of the storage unit when the host unit stores the data to the storage unit; and
a transmission interface control unit coupled to the flash memory register unit for controlling the flash memory register unit.

11. The storage device of claim 10, wherein the transmission interface control unit is utilized for controlling the flash memory register unit to temporarily store the data and for storing the data in the storage unit after a predetermined time or after receiving a specific signal when the host unit stores the data to the storage unit.

12. The storage device of claim 10, wherein the transmission interface control unit is utilized for controlling the flash memory register unit to store the storage information of the storage unit.

13. The storage device of claim 10, wherein the transmission interface control unit is utilized for restoring and recovering the storage unit and/or its interior data by the storage information of the storage unit and the temporarily stored data, stored by the flash memory register unit, when error of transmission between the host unit and the storage unit occurs.

14. The storage device of claim 10, wherein the storage information is a file allocation table (FAT).

15. The storage device of claim 10, wherein the storage information is sector information.

16. The storage device of claim 10, wherein the storage unit is an external storage unit.

17. The storage device of claim 10, wherein the storage unit is a mechanical storage unit.

18. The storage device of claim 17, wherein the storage unit is a hard disk.

19. The storage device of claim 17, wherein the storage unit is an optical disk drive.

20. A data storage method comprising:
temporarily storing data by a flash memory register unit of a storage bridge when a host unit stores the data to a storage unit through the storage bridge;
storing the data to the storage unit; and
storing storage information of the storage unit into the flash memory register unit.

21. The data storage method of claim 20 further comprising:
repairing and recovering the storage unit and/or its interior data by the storage information of the storage unit and the temporarily stored data, stored by the flash memory register unit, when error of transmission between the host unit and the storage unit occurs.

22. The data storage method of claim 20, wherein the storage information is a file allocation table (FAT).

23. The data storage method of claim 20, wherein the storage information is sector information.

24. The data storage method of claim 20, wherein the storage unit is a mechanical storage unit.

25. The data storage method of claim 20, wherein the storage unit is a hard disk.

26. The data storage method of claim 20, wherein the storage unit is an optical disk drive.
